(19) United States
(12) Patent Application Publication
(10) Pub. No.: US 2022/0090589 A1
(43) Pub. Date: Mar. 24, 2022

(54) PUMP COMPRISING AN ELECTRIC MOTOR WITH PLUG CONNECTION IN THE FORM OF AN INTERMEDIATE PLUG

(71) Applicant: NIDEC GPM GmbH, Auengrund OT Merbelsrod (DE)

(72) Inventors: Frank SCHWAMBERGER, Schleusingen (DE); Conrad NICKEL, Troistedt (DE); Jakob SCHNITZER, Hilburghausen (DE)

(21) Appl. No.: 17/417,420

(22) PCT Filed: Jan. 9, 2020
(86) PCT No.: PCT/EP2020/050400

§ 371 Date: Jun. 23, 2021

(30) Foreign Application Priority Data
Jan. 24, 2019 (DE) 10 2019 101 713.0

(51) Int. Cl. F04B 17/03; H02K 3/50; H02K 5/22; H02K 11/33

(52) U.S. Cl. CPC F04B 17/03; H02K 3/50; H02K 2203/03; H02K 11/33; H02K 5/225

(57) ABSTRACT

A pump includes an electric motor with a rotor rotatably mounted about an axis of rotation and circumferentially surrounding a stator. The stator includes a stator core and coils wound on the stator core. The windings are made of a winding wire including winding wire end portions which are electrically contacted with a circuit board on an end side. The rotor, the stator, and the circuit board are surrounded by a motor housing which is adjoined by a pump housing, the circuit board being electrically contacted with an intermediate plug to contact the circuit board with an electrical controller. The intermediate plug includes contacts which are injection-molded into the intermediate plug, are electrically contacted with a first end at the circuit board, include a second end arc directed at least partially radially outwardly, and are introduced into a connecting region of the intermediate plug.

### CROSS REFERENCE TO RELATED APPLICATIONS

This is a U.S. national stage of PCT Application No. PCT/EP2020/050400, filed on Jan. 9, 2020, and with priority under 35 U.S.C. § 119(a) and 35 U.S.C. § 365(b) being claimed from German Application No. 102019101713.0, filed Jan. 24, 2019; the entire disclosures of which are hereby incorporated herein by reference.

### FIELD OF THE INVENTION

The present invention relates to a pump.

### BACKGROUND

Water pumps often feature DC motors. The DC motors comprise a rotor connected to a motor shaft and rotatably mounted in a housing. The rotor is provided with permanent magnets. A stator is arranged in the rotor, which carries a number of windings on an iron core. When suitably controlled, the windings generate a magnetic field that drives the rotor to rotate. The windings are usually wound in three phases and are accordingly provided with three electrical connections through which the windings can be connected to a controller (ECU). At low power levels, busbars in the form of conductor foils can be used. For higher powers, the winding connection wires are contacted via busbars made of copper sheet.

For the purpose of the geometrical description of the electric motor, the axis of rotation of the motor is assumed to be the center axis and axis of symmetry. The rotor is arranged concentrically to the axis of rotation around the stator.

For the electric motors discussed here, in addition to the performance data and weight, the dimensions are also essential. Therefore, it is a constant requirement for the design of electric motors, for example, not to exceed a certain axial length in the direction of the central axis. In this context, the performance data required of the electric motor essentially determine the axial length of the stator pack as well as of the rotor with the electromagnets arranged on it. The busbar unit, which is required for contacting the winding connection wires of the stator, contributes to the axial length.

From the patent specification U.S. Pat. No. 7,588,444 B2, a pump with electric motor is known, which has a busbar unit with a plurality of busbars, wherein the busbar holder is made of an injection-molded, non-conductive thermoplastic resin material.

Conventionally, the connector design requested by the customer is already used when assembling a pump. The design of the pump is therefore customer-specific.

### SUMMARY

Example embodiments of the present disclosure improve pumps each including an electric motor in such a way that the assembly of the pump is as simple as possible and an adaptation of the connector structure can be made afterwards.

Accordingly, a pump including an electric motor according to an example embodiment of the present disclosure includes a rotor which is rotatably supported about an axis of rotation and which circumferentially surrounds a stator. The stator includes a stator core and coils wound on the stator core. The windings are made of a winding wire including winding wire end portions and the winding wire end portions are electrically contacted frontally with a circuit board. The rotor, the stator, and the circuit board are surrounded by a motor housing which is adjoined by a pump housing. The circuit board is electrically contacted with an intermediate plug to contact the circuit board with an electrical control device. The intermediate plug includes contacts which are injection-molded into the intermediate plug and which are electrically contacted with a first end with the circuit board and are directed with a second end at least partially radially outward (to the axis of rotation) and are introduced into a connecting region of the intermediate plug. The connection region is located at least partially within the housing wall of the motor housing and a connector plug with predefined plug geometry and/or plug collar coding is plugged onto the intermediate plug. The intermediate plug has a uniform contact geometry. The connector plugs can have different customer-specific plug geometries, which allow customer-specific use of the pump.

It is advantageous if the pump includes a seal between the intermediate plug and the connection plug, in particular, if the seal includes a sealing element or laser-transparent plastic.

The connector plug preferably extends radially to the axis of rotation and engages in the wall of the motor housing. The connector plug passes at least partially through the motor housing. The plug connection is preferably located inside the wall.

In an example embodiment, the motor housing is substantially pot-shaped and the circuit board is circumferentially surrounded by the motor housing in the region of the opening.

Preferably, the intermediate plug is on a side of the circuit board adjacent to the electric motor, which allows the installation space of the pump to be reduced.

It is advantageous if the contacts in the intermediate connector have a deflection of 90° or about 90°. The connection area then preferably extends in the radial direction to the axis of rotation.

In one example embodiment, the pump housing includes a housing structure including a base plate and a dome projecting centrally from the base plate. The base plate and the dome include a central opening therethrough, and the stator is fixedly seated on the exterior of the dome. A motor shaft of the electric motor, which is non-rotatably connected to the rotor, extends through the central opening of the housing structure.

The contacts of the connector assembly can be press-fit contacts or contacts which are soldered to the circuit board.

The pump can be a dry-running pump and is in particular a water pump, preferably a coolant pump for motor vehicles.

The above and other elements, features, steps, characteristics and advantages of the present disclosure will become more apparent from the following detailed description of the example embodiments with reference to the attached drawings.

### BRIEF DESCRIPTION OF THE DRAWINGS

An example embodiment of the disclosure is explained in more detail below with reference to the drawing.

FIG. 1 shows a longitudinal section of an electric motor of a pump with an intermediate plug.

### DETAILED DESCRIPTION

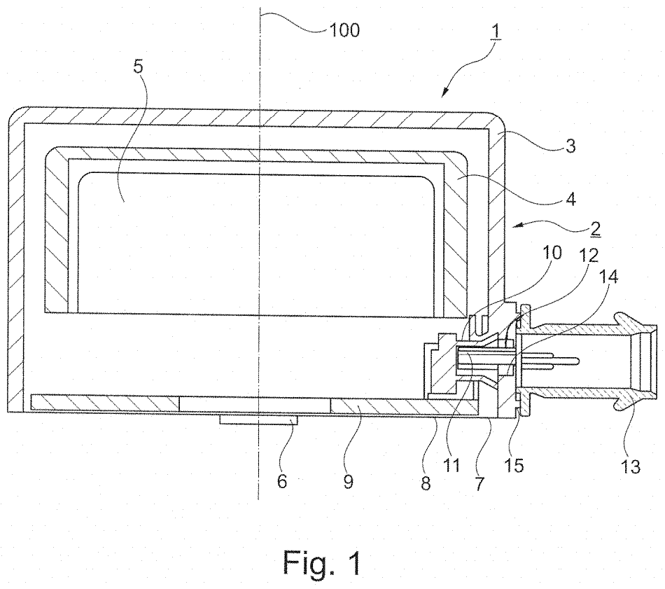

FIG. 1 schematically shows a part of a water pump 1 with an electric motor 2 having a motor housing 3. A rotor 4 and a stator 5, shown only schematically, are arranged in the motor housing 3. The rotor 4 surrounds the stator 5 concentrically to an axis of rotation 100. The rotor 4 is connected to a motor shaft 6 for transmitting a torque. The water pump 1 is designed as a dry rotor. The electric motor 2 is a brushless DC motor. The stator 5 has a stator core which extends coaxially with the axis of rotation 100 and has a plurality of stator core segments, not shown, around each of which coils are wound. The stator 5 is fixedly mounted within the motor housing 3 and is adapted to generate a time-varying magnetic field by way of the coils. The magnetized rotor 4 surrounds the stator 5 circumferentially. It is arranged to be rotated by interaction with the time-varying magnetic field generated by the coils.

The motor housing 3 has a connection for a pump housing not shown. The motor housing 3 is essentially pot-shaped, with the pump housing adjoining the end face 7 in the area of the opening 8. The motor housing 3 circumferentially surrounds a circuit board 9, which is provided for controlling the electric motor 2 with an electric controller. The circuit board 9 is aligned concentrically with the motor shaft 6. The circuit board 9 is electrically connected to the stator of the electric motor 5. The circuit board is electrically contacted with an intermediate connector 10 within the motor housing 3. The contacts 11 of the intermediate plug contact the circuit board 9 on the upper side near the electric motor. The contacts 11 run radially outward within the intermediate plug 10 and are thus bent by about 90°. The intermediate plug 10 is integrated in the housing wall of the motor housing 3. The intermediate plug 10 forms a connection area 12 preferably within the housing wall, which extends in the radial direction. The connection area 12 is universally formed regardless of customer requirements. A connection plug 13 is inserted into the intermediate plug 10. The connector plug 13 is thus inserted in the radial direction into an opening 14 of the motor housing 3 or into the connecting area 12 of the intermediate plug, respectively. To absorb the radial insertion forces when plugging in the connector plug, support elements are to be provided in the intermediate plug towards the motor housing. The plug-in forces are thus not transmitted to the circuit board.

The intermediate connector 10 has a uniform contact geometry for electrical contacting. The connector plug 13 can be designed differently and thus customer-specifically. Different plug variants with different plug collar codes can be easily implemented in the manufacturing process. The connector plug is not assembled until the final stage of pump assembly. Until then, the assembly is identical for each customer, regardless of the connector structure. Due to the connection angle of the intermediate plug 10, the connection plug 13 can be made straight and thus particularly simple. A seal 15 between the intermediate plug 10 and the connection plug 13 can also be easily implemented with a sealing element or laser-transparent plastic.

The contacts 11 are preferably connected to the circuit board 9 by forming a press-fit connection. However, conventional solder connections or flat solder contacts can also be provided for making the connection.

The motor housing 3 is injection molded and preferably formed of plastic.

While example embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

1-10. (canceled)

11. A pump, comprising:
an electric motor with a rotor which is rotatably mounted about an axis of rotation and which circumferentially surrounds a stator, the stator includes a stator core and coils wound on the stator core; wherein
the windings are made of a winding wire with winding wire end sections, the winding wire end sections being electrically contacted with a circuit board;
the rotor, the stator, and the circuit board are surrounded by a motor housing which is adjoined with a pump housing;
the circuit board is electrically contacted to an intermediate plug to contact the circuit board with an electrical controller;
the intermediate plug includes contacts which are injection-molded into the intermediate plug and which are electrically contacted at a first end with the circuit board, are directed at least partially radially outwards at a second end, and are introduced into a connecting region of the intermediate plug; and
the connecting region is located at least partially within the housing wall of the motor housing and a connector plug with predefined plug geometry and/or plug collar coding is plugged onto the intermediate plug.

12. The pump according to claim 11, wherein the pump includes a seal between the intermediate plug and the connection plug.

13. The pump according to claim 11, wherein the connector plug extends radially to the axis of rotation and engages with the wall of the motor housing.

14. The pump according to claim 11, wherein the motor housing is pot-shaped and the circuit board is circumferentially surrounded by the motor housing in a region of the opening.

15. The pump according to claim 11, wherein the intermediate connector is on a side of the circuit board adjacent to the electric motor.

16. The pump according to claim 11, wherein the contacts in the intermediate plug have a deflection of 90° or about 90° .

17. The pump according to claim 11, wherein the pump housing includes a housing structure which includes a base plate and a dome projecting centrally from the base plate;
the base plate and the dome include a central opening passing therethrough;
the stator is seated fixedly on an outside of the dome; and
a motor shaft of the electric motor, which is connected rotationally to the rotor, passes through the central opening of the housing portion.

18. The pump according to claim 11, wherein the pump is a dry rotor pump.

19. The pump according to claim 11, wherein the contacts are press-fit contacts or contacts which are soldered onto the circuit board.

20. The pump according to claim 11, wherein the intermediate plug includes supports extending towards the motor housing, the supports are structured to absorb the radial plug-in forces when the connection plug is plugged on.
